(19) United States
(12) Patent Application Publication
(10) Pub. No.: US 2013/0191659 A1
(43) Pub. Date: Jul. 25, 2013

(54) Load Control of Demand Response Network Devices

(71) Applicants: Bradley Richard Ree, Atlanta, GA (US); George Alexander, Atlanta, GA (US)

(72) Inventors: Bradley Richard Ree, Atlanta, GA (US); George Alexander, Atlanta, GA (US)

(73) Assignee: GENERAL ELECTRIC COMPANY, Schenectady, NY (US)

(21) Appl. No.: 13/356,222

(22) Filed: Jan. 23, 2012

(51) Int. Cl. G06F 15/177; G06F 1/32

(52) U.S. Cl. 713/310; 709/220

(57) ABSTRACT

Embodiments of the invention can provide systems and methods for controlling the load of demand response network devices. According to one embodiment of the invention, a system can be provided. The system can be operable to determine a desired load control configuration for a network of devices, generate a load control message based at least in part on the desired load control configuration, and transmit the load control message to the network of devices.

### FIELD OF THE INVENTION

Embodiments of the invention relate generally to load control, and more particularly to load control of demand response network devices.

### BACKGROUND OF THE INVENTION

A wide variety of utility meters are configured to measure consumption and/or communicate with other network devices. For example, smart meters are configured to transmit messages containing consumption data and/or other monitoring data to households appliances as well as servers and/or controllers. With any communication network or communication technique that may be utilized by a utility meter, there is energy consumption, however negligible. For example, a network radio may consume energy while measuring consumption and/or while communicating with the headend server. Additionally, some of this consumption may occur at peak times. Given the growing number of smart meters being deployed at consumption locations, there is an opportunity for consumption saving methods for utility meters that transmit messages.

### BRIEF DESCRIPTION OF THE INVENTION

Some or all of the above needs and/or problems may be addressed by certain embodiments of the invention. Disclosed embodiments may include load control for demand response network devices. According to one embodiment of the invention, there is disclosed a system operable to determine a desired load control configuration for a network of devices; generate a load control message based on the desired load control configuration; and transmit the load control message to the network of devices.

According to another embodiment of the invention, there is disclosed a method for determining a desired load control configuration for at least one of a network, an advanced metering infrastructure (AMI) device, a meter, a home area network (HAN) device, or a demand response device; generating, based at least in part on the desired load control configuration, a load control message; and transmitting the load control message to the network, the AMI device, the meter, the HAN device, or the demand response device.

Further, according to another embodiment of the invention, there is disclosed one or more computer-readable media storing instructions for determining a desired load control configuration for at least one of a network, an AMI device, a meter, a HAN device, or a demand response device; generating, based at least in part on the desired load control configuration, a load control message; and transmitting the load control message to the network, the AMI device, the meter, the HAN device, or the demand response device.

Other embodiments, aspects, and features of the invention will become apparent to those skilled in the art from the following detailed description, the accompanying drawings, and the appended claims.

### BRIEF DESCRIPTION OF THE DRAWINGS

Reference will now be made to the accompanying drawings, which are not necessarily drawn to scale, and wherein:

FIG. 1 is a block diagram of a computer environment showing an illustrative system with which load control of demand response network devices may be implemented, according to an embodiment of the invention.

FIG. 2 is a flow diagram illustrating details of an example method for implementing load control of demand response network devices, according to an embodiment of the invention.

### DETAILED DESCRIPTION OF THE INVENTION

Illustrative embodiments of the invention will now be described more fully hereinafter with reference to the accompanying drawings, in which some, but not all embodiments of the invention are shown. The invention may be embodied in many different forms and should not be construed as limited to the embodiments set forth herein; rather, these embodiments are provided so that this disclosure will satisfy applicable legal requirements. Like numbers refer to like elements throughout.

Illustrative embodiments of the invention are directed to, among other things, controlling loads of one or more metering devices. In some examples, the metering devices may include network devices such as, but not limited to, demand response meters, smart meters, advanced metering infrastructure (AMI) devices, and/or home area network (HAN) devices. In some aspects, in particular, illustrative embodiments of the invention may be directed towards providing load control messages and/or instructions to demand response network devices to shed grid loads based on a wide variety of factors and/or scenarios. For example, messages and/or instructions may be transmitted to smart meters that, in some examples, may include AMI and/or HAN radios. The messages and/or instructions may, in some cases, instruct the meter to put the AMI networks in a low power mode for a predetermined amount of time, to put the meter processor or processors in a low power mode for a predetermined amount of time, and/or to put the HAN network into a low power mode for a predetermined amount of time.

As an overview, utility companies or other electricity providers generate and/or provide electricity to a grid. The grid may provide electricity to customers who consume the electricity or to other utility companies. Additionally, in some examples, a grid may transmit electricity to a headend server for controlling one or more other sub-grids, electricity networks, and/or other consumers or customers. Further, in some examples, the headend server may provide instructions to one or more networks of devices, each network including one or more AMI devices, smart meters, HAN devices, and/or household appliances. As such, the headend may be configured to place one or more of the elements (i.e., devices) into a low power mode (i.e., a load shedding mode). For example, a portion of an AMI system may be placed in a low power mode to reduce potentially wasted power used by the AMI radios. In some examples, this may be especially useful during peak usage time. Further, and by way of example only, the headend server may be configured to generate one or more load control signals or messages for a group (i.e., a network) of AMI radios, meters, and/or HAN systems. The message may include a group ID, a start time, a length of low power mode, and/or an indication of a randomization of the length of a low power mode.

In some examples, when an AMI radio is to be controlled, the radios may be instructed to enter a low power mode while maintaining link keys to allow for a quick restart of the network. Additionally, in some examples, when a meter is to be controlled, certain high power/non-critical devices of the meter may be instructed to enter a low power mode. For example, advanced meter functions may be disabled or the meter display may be turned off while basic metrology may still run. Further, in other examples, when the HAN systems are to be controlled, power line carrier modems and radios may be instructed to enter a low power mode for a predetermined amount of time. In this example, similar to with the AMI radios, link keys may be maintained in order to facilitate quickly restarting the network when requested.

The technical effects of embodiments of the invention may include shedding utility loads during peak power times by shifting the load utilized by AMI devices, meters, and/or HAN devices. In addition, embodiments of the invention will allow for load shedding with minimal effect to the end customer.

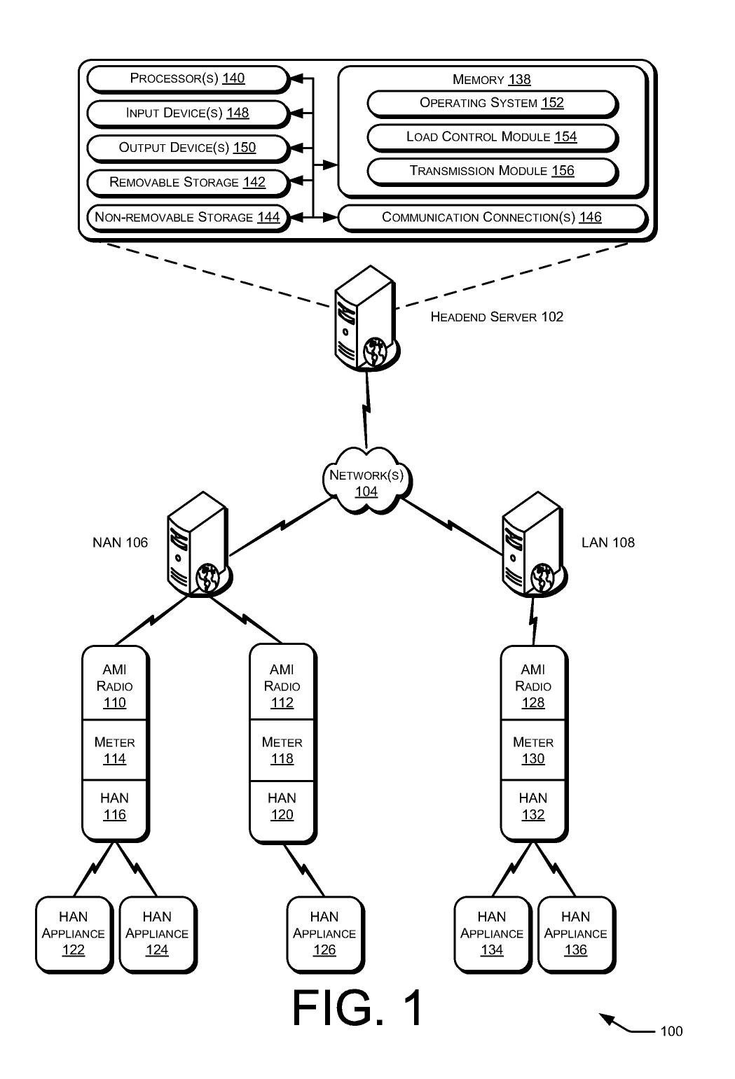

FIG. 1 provides an illustrative overview of one system 100, in which aspects and features disclosed herein may be implemented. The system may include a headend server 102 configured to connect to one or more networks 104 such as, but not limited to, the Internet, other public networks, and/or private networks. In some examples, the headend server 102 may be in communication with one or more Near-me Area Network (NAN) computing devices 106, one or more Local Area Network (LAN) devices 108, and/or one or more other types of network devices such as, but not limited, servers computers, server farms, or the like. Further, in some examples, the NAN device 106 may in communication with one or more AMI radios such as, but not limited to, AMI radio 110 and/or AMI radio 112.

Additionally, as shown in FIG. 1, in some examples, the AMI radio 110 may be connected to, integrated with, or otherwise configured to communicate and/or control a meter 114. The meter 114 may be a smart meter or other type of metering device that may accept instructions and/or perform operations for measuring electricity and/or power consumption, regulating consumption, and/or displaying consumption information. In turn, the meter 114 may also be in communication with one or more HAN devices 116. Similarly, the AMI radio 112 may be in communication with a meter 118, which may also be in communication with one or more other HAN devices 120. Further, in some aspects, the HAN device 116 may be communicatively coupled or otherwise in communication with one or more HAN appliances 122 and 124. Similarly, the HAN device 120 may in communication with one or more HAN appliances 126.

In some examples, as shown in FIG. 1, a meter 110 may be configured or otherwise integrated with either or both of an AMI radio and/or a HAN device such as, but not limited to the devices 114 and 116. In this way, the meter may be in communication with a NAN device or network such as, but not limited to, NAN 106 and/or the HAN appliances 122 and/or 124. For example, the AMI radio 110 may act as a network interface for receiving instructions over a network from the NAN 106. Similarly, the HAN device 116 may act as a network interface for transmitting instructions over a network to the HAN appliances 112 and/or 124. In some examples, each meter may exist or otherwise be connected to a home, business, or other structure for monitoring, measuring, and/or controlling electricity and/or power consumption at the structure. Additionally, each HAN device may be configured for controlling one or of the HAN appliances or other devices that may be located within, near, around, or associated with the structure.

Additionally, or in the alternative, the headend server 102 may be in communication with one or more other types of networks such as, but not limited to, the LAN 108. As such, the headend server 102 may also be configured to transmit control signals through the LAN 108, via an AMI radio 128, to a meter 130. Much like the meters 114 and/or 118, the meter 130 may also be in communication with, via a HAN device 132, one or more other HAN appliances 134 and/or 136. As such, any number of HAN appliances and/or any number of meters may be controlled or otherwise monitored by the headend server 102 via the one or more networks 104. Additionally, and as noted above, each meter may be configured or otherwise integrated with one or more AMI radios for communicating with NAN or LAN devices and/or one or more HAN devices (or radios) for communicating with HAN appliances or other HAN devices within a home, business, building, or other structure.

In one illustrative configuration, the headend server 102 may comprise at least a memory 138 and one or more processing units (or processor(s)) 140. The processor(s) 140 may be implemented as appropriate in hardware, software, firmware, or combinations thereof. Software or firmware implementations of the processor(s) 140 may include computer-executable or machine-executable instructions written in any suitable programming language to perform the various functions described.

Memory 138 may store program instructions that are loadable and executable on the processor(s) 140, as well as data generated during the execution of these programs. Depending on the configuration and type of the headend server 102, the memory 138 may be volatile (such as random access memory (RAM)) and/or non-volatile (such as read-only memory (ROM), flash memory, etc.). The computing device or server may also include additional removable storage 142 and/or non-removable storage 144 including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 138 may include multiple different types of memory, such as static random access memory (SRAM), dynamic random access memory (DRAM), or ROM.

The memory 138, the removable storage 142, and the non-removable storage 144 are all examples of computer-readable storage media. For example, computer-readable storage media may include volatile and non-volatile, removable and non-removable media implemented in any method or technology for storage of information such as computer-readable instructions, data structures, program modules or other data. The memory 138, the removable storage 142, and the non-removable storage 144 are all examples of computer storage media. Additional types of computer storage media that may be present include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile discs (DVD) or other optical storage, magnetic cassettes, magnetic tape, magnetic disk storage or other magnetic storage devices, or any other medium which can be used to store the desired information and which can be accessed by the server or other computing device. Combinations of any of above should also be included within the scope of computer-readable media.

Alternatively, computer-readable communication media may include computer-readable instructions, program modules, or other data transmitted within a data signal, such as a carrier wave, or other transmission. However, as used herein, computer-readable storage media does not include computer-readable communication media.

The headend server 102 may also contain communications connection(s) 146 that allow the headend server 102 to communicate with a stored database, another computing device or server, user terminals, and/or other devices on a network such as, but not limited to the networks 104. The headend server 102 may also include input device(s) 148 such as a keyboard, mouse, pen, voice input device, touch input device, etc., and output device(s) 150, such as a display, speakers, printer, etc.

Turning to the contents of the memory 138 in more detail, the memory 138 may include an operating system 152 and one or more application programs or services for implementing the features disclosed herein including a load control module 154 and/or a transmission module 156. In some aspects, the load control module 154 may be configured to determine load control preferences, settings, and/or configurations for one or more network devices and/or for a network of devices. In one example, the load control module 154 may receive information associated with peak load times and/or demand response information from an electricity provider or other service provider. Based at least in part on this information and/or user preferences associated with the network devices and/or the network of devices. Additionally, the load control module 154 may also receive information associated with consumption configurations of each network device. For example, a first meter may utilize different amounts of energy during monitoring, display, and/or other operating processes.

Further, in some examples, the load control module 154 may determine particular configurations for each meter, AMI radio, and/or HAN device. For example, in one example, the load control module 154 may determine at what times and for how long a particular meter should enter a low power mode. Additionally, the load control module 154 may also determine particular configurations and/or settings for when and how long to place AMI radios and/or particular HAN devices into low power modes. Further, as noted above, random numbers may be used for instructing the meters, the AMI radios, and/or the HAN devices (or radios) how long to remain in low power modes and/or what times to enter regular power modes. In this way, a large number of devices may not all return to regular power at the same time or similar times, potentially causing a overload on the grid. Additionally, in some aspects, the load control signal determined or generated by the load control module 154 may include an instruction for the AMI radios and/or the HAN radios to record, maintain, or otherwise store network link keys to facilitate returning on-line from an off-line, or low power, state.

The memory 138 may also include a transmission module 156 for transmitting the control signal determined by the load control module 154. In some examples, the transmission module 156 may utilize the communication connections 146 for facilitating the transmission. In some aspects, the transmission module 156 may be configured to continuously update the AMI radios with control signals. However, in other aspects, the transmission module 156 may transmit the control signals on a periodic basis, during high peak or low peak times, based on requests from the AMI radios, meters, and/or HAN devices, and/or randomly.

Further, in some aspects, the load control module 154 may be configured to construct a message to put an entire AMI network, or a single AMI radio, in a low power mode for a predefined period of time, plus or minus a second predefined period. The load control module 154 may also be configured to construct a message to put an application processor located within a meter in a low power mode for a predefined period of time. In some examples, this may disable advanced metering functions during the peak times, but may also reduce power consumption of the meter. Further, in some examples, the load control module 154 may put an entire HAN network, or a single HAN device or radio, in a low power mode for a predefined period of time, plus or minus a second predefined period.

Various instructions, methods and techniques described herein may be considered in the general context of computer-executable instructions, such as program modules, executed by one or more computers or other devices. Generally, program modules include routines, programs, objects, components, data structures, etc., for performing particular tasks or implementing particular abstract data types. These program modules and the like may be executed as native code or may be downloaded and executed, such as in a virtual machine or other just-in-time compilation execution environment. Typically, the functionality of the program modules may be combined or distributed as desired in various embodiments. An implementation of these modules and techniques may be stored on some form of computer-readable storage media.

The example headend server 102 shown in FIG. 1 is provided by way of example only. Numerous other operating environments, system architectures, and device configurations are possible. Accordingly, embodiments of the present disclosure should not be construed as being limited to any particular operating environment, system architecture, or device configuration.

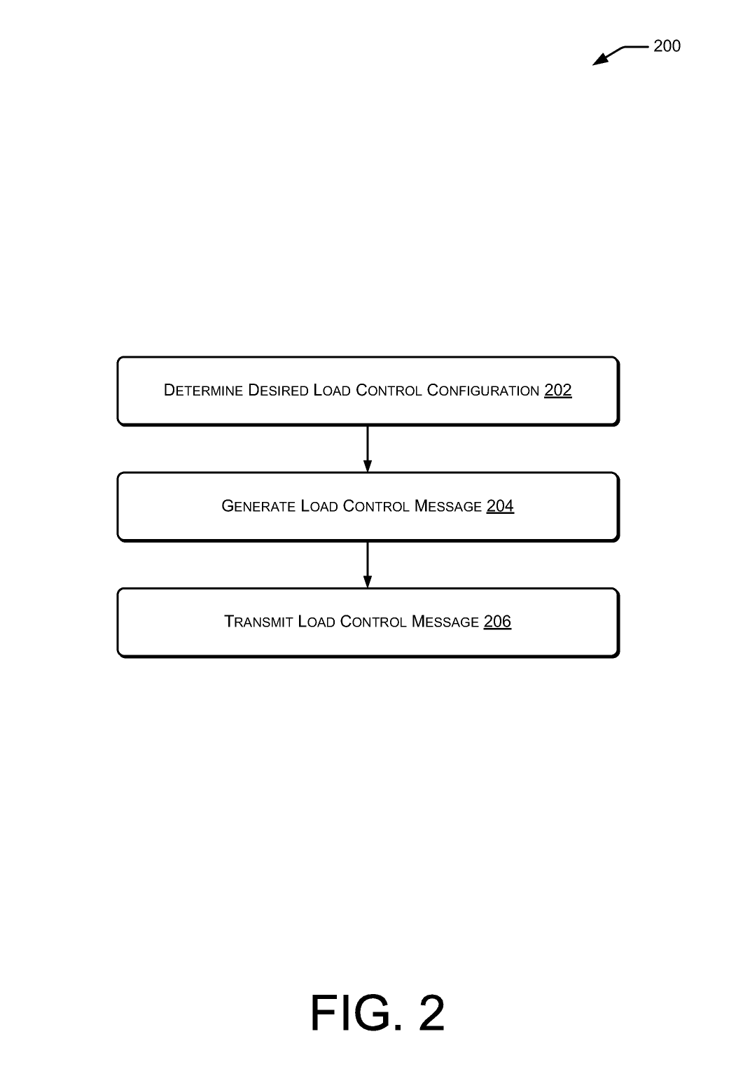

FIG. 2 is a flow diagram of the illustrative process 200 for implementing the load control of demand response network devices, as described with reference to FIG. 1. This process is illustrated as a logical flow diagram, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process.

FIG. 2 illustrates an example flow diagram of process 200 for implementing the load control of demand response network devices, as discussed above. In one example, the illustrative headend server 102 and/or one or more modules 154 or 156 of the illustrative headend server 102, alone or in combination, may perform the described operations of process 200.

In this particular implementation, the process 200 may begin at block 202 of FIG. 2 in which the process 200 may determine a desired load control configuration. In some examples, determining the desired load condition may include making a determination based, in part, on user control settings, demand response settings, peak load times and/or intervals, consumption statistics, and/or factory settings of one or more meters, AMI radios, and/or HAN radios (or devices). As such, the load control configuration determined at block 202 may include one or more settings for low power mode start times, low power mode stop times, low power mode intervals, which components are to be placed in low power mode and for how long (e.g., one setting may indicate that the display screen should be turned off during peak load times while another setting may indicate that metering should only take place every 10 seconds, 30 seconds, 60 seconds, etc.).

At block 204, the process 200 may generate a load control message. In some instances, the load control message may include the load control configuration determined at block 202. Additionally, in some aspects, the load control message may be formatted in any form such as, but not limited to, Hypertext Markup Language (HTML), Extensible Markup Language (XML), Simple Object Access Protocol (SOAP), Hypertext Transfer Protocol (HTTP), Simple Mail Transfer Protocol (SMTP), text message, or any other machine-readable form. At block 206, the process 200 may terminate by transmitting the load control message. That is, in some aspects, the process 200 may transmit the message generated at block 204 to one or more networks of devices, network devices such as, but not limited to, the NAN 106 or the LAN 108 of FIG. 1, and/or to one or more meters (whether network-based or not). In this way, the message may provide control instructions to meters, AMI radios, and/or HAN devices for shedding grid loads during high peak times and/or based on user settings or preferences.

Illustrative methods and systems of implementing the load control of demand response network devices are described above. Some or all of these systems and methods may, but need not, be implemented at least partially by architectures such as those shown in FIG. 1 above.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments.

That which is claimed:

1. A system, comprising:
at least one memory which stores computer-executable instructions;
at least one processor coupled to the at least one memory, configured to:
execute the computer-executable instructions stored in the at least one memory;
determine a desired load control configuration for a network of devices; and
generate a load control message based at least in part on the desired load control configuration; and
a transmission device coupled to the at least one processor configured to transmit the load control message to the network of devices.

2. The system of claim 1, wherein the network of devices comprises at least one of an advanced metering infrastructure (AMI) device, a utility meter, a home area network (HAN) device, or a demand response device.

3. The system of claim 1, wherein the network of devices communicates with a utility company via a network connection.

4. The system of claim 3, wherein the network connection comprises at least one of a neighborhood area network (NAN), an AMI network, or a HAN.

5. The system of claim 1, wherein the desired load control configuration is determined based at least in part on at least one of peak time or load shedding.

6. The system of claim 1, wherein the load control message comprises at least one of a group identifier (ID), a start time, a length, or a randomization indication.

7. The system of claim 1, wherein the load control message instructs a radio of an AMI device to decrease power consumption.

8. The system of claim 7, wherein the load control message further instructs the radio of the AMI device to maintain a network link key.

9. The system of claim 1, wherein the load control message instructs a non-critical device of a meter to decrease power consumption.

10. The system of claim 9, wherein the non-critical device comprises at least one of an advanced meter function device or a display device.

11. The system of claim 1, wherein the load control message instructs at least one of a modem or a radio of a HAN device to decrease power consumption.

12. A method, comprising:
determining, by at least one processor coupled to at least one memory, a desired load control configuration for at least one of a network, an advanced metering infrastructure (AMI) device, a meter, a home area network (HAN) device, or a demand response device;
generating, based at least in part on the desired load control configuration, a load control message; and
transmitting, by a transmission device coupled to the at least one processor, the load control message to the at least one of the network, the AMI device, the meter, the HAN device, or the demand response device.

13. The method of claim 12, wherein the desired load control configuration is determined based at least in part on at least one of peak time or load shedding.

14. The method of claim 12, wherein the load control message comprises at least one of a group identifier (ID), a start time, a length, or a randomization indication.

15. The method of claim 12, wherein the load control message instructs a radio of an AMI device to decrease power consumption.

16. The method of claim 15, wherein the load control message further instructs the radio of the AMI device to maintain a network link key.

17. The method of claim 12, wherein the load control message instructs a non-critical device of a meter to decrease power consumption.

18. The method of claim 17, wherein the non-critical device comprises at least one of an advanced meter function device or a display device.

19. The method of claim 12, wherein the load control message instructs at least one of a modem or a radio of a HAN device to decrease power consumption.

20. One or more computer-readable media storing computer-executable instructions that, when executed by at least one processor, configure the at least one processor to perform operations comprising:
determining a desired load control configuration for at least one of a network, an advanced metering infrastructure (AMI) device, a meter, a home area network (HAN) device, or a demand response device;
generating, based at least in part on the desired load control configuration, a load control message for the at least of a network, an AMI device, a meter, a HAN device, or a demand response device; and
transmitting the load control message to the at least one of the network, the AMI device, the meter, the HAN device, or the demand response device.
